(19) United States
(12) Patent Application Publication
(10) Pub. No.: US 2016/0335312 A1
(43) Pub. Date: Nov. 17, 2016

(54) UPDATING ASSET REFERENCES

(71) Applicant: eBay Inc., San Jose, CA (US)

(72) Inventor: Ethan Bickford Martin, Bryn Mawr, PA (US)

(21) Appl. No.: 14/712,810

(22) Filed: May 14, 2015

(51) Int. Cl. G06F 17/30; H04L 29/08

(52) U.S. Cl. CPC G06F 17/30377; H04L 67/02; G06F 17/30174; H04L 67/1095; G06F 17/30893

(57) ABSTRACT

In various example embodiments, a system and method for updating asset references are presented. A plurality of assets is organized into one or more groups including a first group of assets and a second group of assets. A dependency between a first asset from the first group of assets and a second asset from the second group of assets identified. The dependency corresponds to a feature of a web page. A change to a component of the second asset is detected. The dependency is updated in response to the detected change. Display of the feature of the web page is caused based on the updated dependency between the first asset and the second asset.

### TECHNICAL FIELD

Embodiments of the present disclosure relate generally to data processing and, more particularly, but not by way of limitation, to updating asset references.

### BACKGROUND

Conventionally, when a previous version of an asset is updated to a new version of that asset, a file name of the asset is also changed as a result of the update.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments.

FIG. 2 is a block diagram illustrating components of an asset system, according to some example embodiments.

FIGS. 3-5 are flowcharts illustrating operations of the asset system in performing a method of updating a dependency between a first asset and a second asset, according to some example embodiments.

FIG. 6 is a block diagram illustrating an example user interface of a product page, according to some example embodiments.

FIG. 7 is a block diagram illustrating an example user interface of a product page and a product reviews page, according to some example embodiments.

FIG. 8 illustrates a diagrammatic representation of a machine in the form of a computer system within which a set of instructions may be executed for causing the machine to perform any one or more of the methodologies discussed herein, according to an example embodiment.

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

In various example embodiments a system is provided that updates asset references. An asset may represent a file that is used to control a feature of a web page. Moreover, the asset is updated over time in order to update the feature of the web page. Once the asset is updated, a file name of the updated asset may also change to a new file name. In example embodiments, the updated asset is referenced by a further asset which depends on the updated asset. In other words, the further asset may have a function that refers to the updated asset by its file name. Accordingly, the system updates a reference to the updated asset. The system accomplishes this by automatically identifying the further asset which depends on the updated asset and updating the further asset to reflect the new file name of the updated asset. This saves a burden on behalf of a user to manually identify a plurality of further assets and updating them individually.

Accordingly, one or more of the methodologies discussed herein may obviate a need for manual identification of further assets which reference an updated asset, which may have the technical effect of reducing computing resources used by one or more devices within the system. Examples of such computing resources include, without limitation, processor cycles, network traffic, memory usage, storage space, and power consumption.

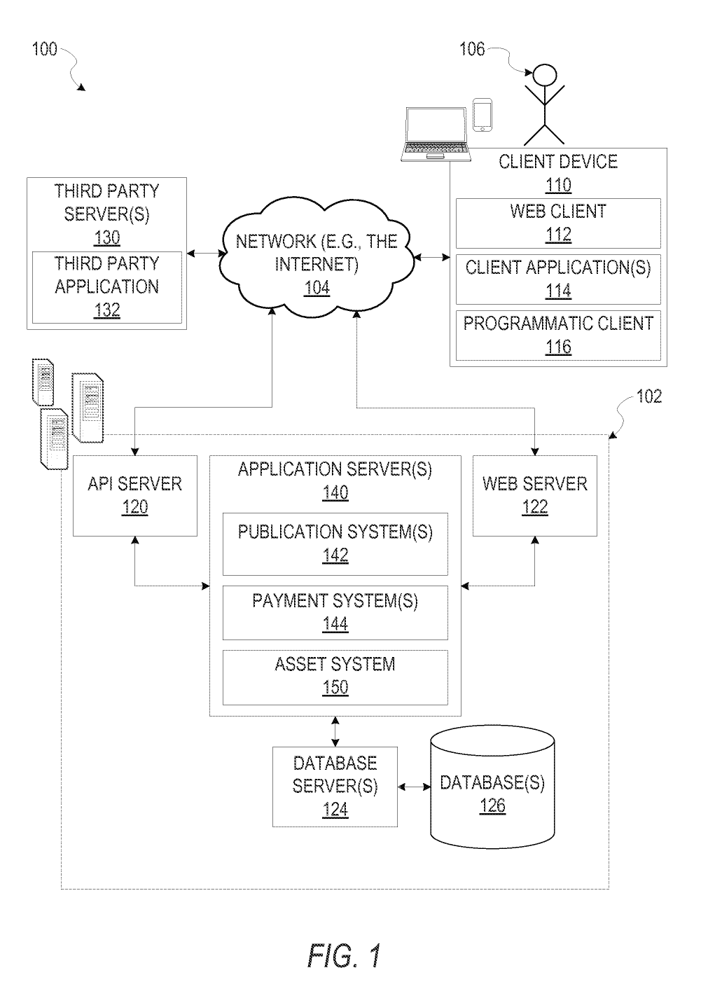

With reference to FIG. 1, an example embodiment of a high-level client-server-based network architecture 100 is shown. A networked system 102, in the example forms of a network-based publication system, provides server-side functionality via a network 104 (e.g., the Internet or wide area network (WAN)) to one or more client devices 110. FIG. 1 illustrates, for example, a web client 112 (e.g., a browser, such as the Internet Explorer® browser developed by Microsoft® Corporation of Redmond, Wash. State), an application 114, and a programmatic client 116 executing on client device 110.

The client device 110 may comprise, but is not limited to, a mobile phone, desktop computer, laptop, portable digital assistants (PDAs), smart phones, tablets, ultra-books, netbooks, laptops, multi-processor systems, microprocessor-based or programmable consumer electronics, game consoles, set-top boxes, or any other communication device that a user may utilize to access the networked system 102. In some embodiments, the client device 110 comprises a display module (not shown) to display information (e.g., in the form of user interfaces). In further embodiments, the client device 110 may comprise one or more of a touch screens, accelerometers, gyroscopes, cameras, microphones, global positioning system (GPS) devices, and so forth. The client device 110 is a device of a user that is used to perform an operation involving digital items or content within the networked system 102. In one embodiment, the networked system 102 is a network-based marketplace that responds to requests for product listings, publishes publications comprising item listings of products available on the network-based marketplace, and manages payments for these marketplace transactions. One or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The client device 110 includes one or more applications (also referred to as “apps”) such as, but not limited to, a web browser, messaging application, electronic mail (email) application, an e-commerce site application (also referred to as a marketplace application), and the like. In some embodiments, if the e-commerce site application is included in a given one of the client device 110, then this application is configured to locally provide the user interface and at least some of the functionalities with the application configured to communicate with the networked system 102, on an as needed basis, for data or processing capabilities not locally available (e.g., access to a database of items available for sale, to authenticate a user, to verify a method of payment). Conversely if the e-commerce site application is not included in the client device 110, the client device 110 may use its web browser to access the e-commerce site (or a variant thereof) hosted on the networked system 102.

One or more users 106 may be a person, a machine, or other means of interacting with the client device 110. In example embodiments, the user 106 is not part of the network architecture 100, but may interact with the network architecture 100 via the client device 110 or other means. For instance, the user provides input (e.g., touch screen input or alphanumeric input) to the client device 110 and the input is communicated to the networked system 102 via the network 104. In this instance, the networked system 102, in response to receiving the input from the user, communicates information to the client device 110 via the network 104 to be presented to the user. In this way, the user can interact with the networked system 102 using the client device 110.

An application program interface (API) server 120 and a web server 122 are coupled to, and provide programmatic and web interfaces respectively to, one or more application servers 140. The application servers 140 may host one or more publication systems 142 and payment systems 144, each of which may comprise one or more modules or applications and each of which may be embodied as hardware, software, firmware, or any combination thereof. The application servers 140 are, in turn, shown to be coupled to one or more database servers 124 that facilitate access to one or more information storage repositories or database(s) 126. In an example embodiment, the databases 126 are storage devices that store information to be posted (e.g., publications or listings) to the publication system 142. The databases 126 may also store digital item information in accordance with example embodiments.

Additionally, a third party application 132, executing on third party server(s) 130, is shown as having programmatic access to the networked system 102 via the programmatic interface provided by the API server 120. For example, the third party application 132, utilizing information retrieved from the networked system 102, supports one or more features or functions on a website hosted by the third party. The third party website, for example, provides one or more promotional, marketplace, or payment functions that are supported by the relevant applications of the networked system 102.

The publication systems 142 may provide a number of publication functions and services to users 106 that access the networked system 102. The payment systems 144 may likewise provide a number of functions to perform or facilitate payments and transactions. While the publication system 142 and payment system 144 are shown in FIG. 1 to both form part of the networked system 102, it will be appreciated that, in alternative embodiments, each system 142 and 144 may form part of a payment service that is separate and distinct from the networked system 102. In some embodiments, the payment systems 144 may form part of the publication system 142.

The asset system 150 may provide functionality operable to manage and update asset references. For example, the asset system 150 accesses a plurality of assets from the databases 126, the third party servers 130, the publication system 142, and other sources. In some example embodiments, the asset system 150 organizes the plurality of assets into one or more groups and analyzes the plurality of assets to identify dependencies among them. Upon identifying the dependencies, the asset system 150 updates the dependencies in an event one of the assets becomes updated or changed. In some example embodiments, the asset system 150 may communicate with the publication systems 142 (e.g., accessing item listings) and payment system 144.

Further, while the client-server-based network architecture 100 shown in FIG. 1 employs a client-server architecture, the present inventive subject matter is of course not limited to such an architecture, and could equally well find application in a distributed, or peer-to-peer, architecture system, for example. The various publication system 142, payment system 144, and asset system 150 could also be implemented as standalone software programs, which do not necessarily have networking capabilities.

The web client 112 accesses the various publication and payment systems 142 and 144 via the web interface supported by the web server 122. Similarly, the programmatic client 116 accesses the various services and functions provided by the publication and payment systems 142 and 144 via the programmatic interface provided by the API server 120. The programmatic client 116 may, for example, be a seller application (e.g., the Turbo Lister application developed by eBay® Inc., of San Jose, Calif.) to enable sellers to author and manage listings on the networked system 102 in an off-line manner, and to perform batch-mode communications between the programmatic client 116 and the networked system 102.

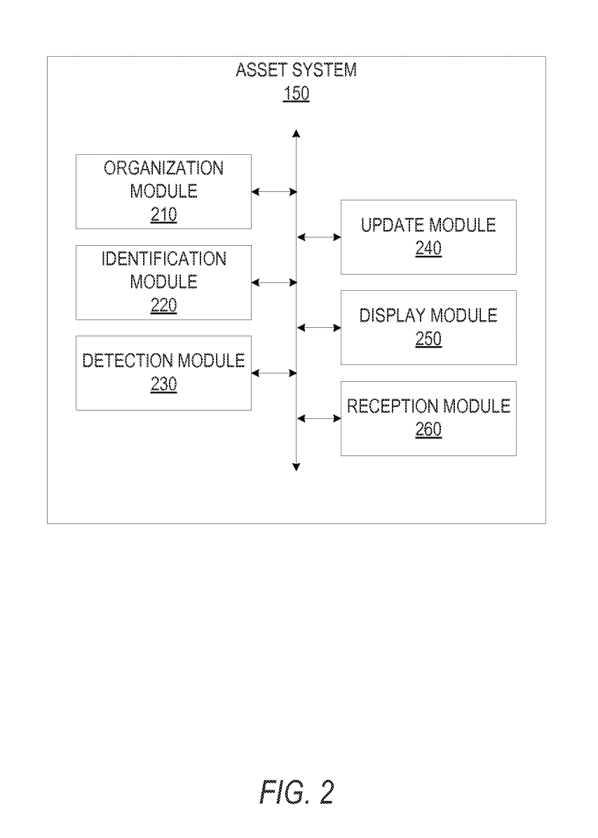

FIG. 2 is a block diagram illustrating components of the asset system 150, according to some example embodiments. The asset system 150 is shown as including an organization module 210, an identification module 220, a detection module 230, an update module 240, a display module 250, and a reception module 260, all configured to communicate with each other (e.g., via a bus, shared memory, or a switch). Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

In various example embodiments, the organization module 210 is configured to organize a plurality of assets into one or more groups. In some instances, the assets represent one or more files. The files include source code which is used to control various features of a web page. In some instances, the files include images or graphics that are displayed on the web page (e.g., an item or product page for an item listing). In some instances, the files control the formatting or the functionality of the web page. For example, an asset may be a Cascading Style Sheets CSS file which is used in displaying the item page or a product reviews page of the item. As another example, an asset may be an image that is displayed to the user as part of the product reviews page of the item. Accordingly, the assets comprise one or more asset types. Examples include Cascading Style Sheets (CSS) files, JavaScript files, image files, and the like.

In various example embodiments, the organization module 210 organizes the plurality of assets into a first group and a second group. In other words, the organization module 210 places each of the plurality of assets into a certain group among the one or more groups. In some instances, the assets are placed within each group based on their association with a specific feature of the web page. For example, all of the assets placed into the first group may be identified based on their association with a specific feature of the web page. Moreover, all of the assets placed into the first group may also share a filename that is used to indicate the associated feature. For example, the first group of assets may be identified as a group that is related to the product reviews page of the item, and files from the first group of assets may have “product-reviews” as part of the filename. As another example, the second group of assets may be identified as a group that is related to the product page itself, and files from the second group may have “product-page” as part of the filename.

In various example embodiments, the identification module 220 is configured to identify dependencies between the first group of assets and the second group of assets. For example, the assets related to the product reviews page of the item may also depend on the assets related to the product page. In some instances, the assets rely on one another in order to display a specific feature of the web page. More particularly, the identification module 220 identifies a dependency between a first asset from the first group of assets and a second asset from the second group of assets. In some instances, the identification module 220 is further to identify a dependency between the first asset from the first group of assets and one or more assets from the second group of assets.

Additionally, the source code of the first asset may include a function that uses the second asset as one of its inputs. Therefore, the identification module 220 further identifies a function within the first asset that references the second asset. In other words, the function within the first asset will include a filename of the second asset as one of its parameters. Upon identification, the identification module 220 generates a comment in a source code of the first asset that indicates the second asset. The comment may be an extra line that is used as a flag to indicate to the update module 240 about the dependency, as further explained below. Moreover, the dependency between the first asset and the second asset may be used to display the specific feature of the web page.

In various example embodiments, the detection module 230 is configured to detect a change to a component of the second asset. In various embodiments, the detection module 230 detects a change in a file name of the second asset. This is due to the fact that, in some instances, the file name of the second asset is changed to a new file name once the source code of the second asset has been changed. For example, the file name may be changed from “product-reviews.abcdef.css” to “product-reviews.tuvwxyz.css.” The file name of the second asset is changed such that a client device will send a request to retrieve the changed second asset. This is because, in some instances, the previous version second asset becomes cached or stored on the client device and is recognized by the client device by the previous filename. In various example embodiments, the detection module 230 is configured to receive a query parameter that references the second asset. The query parameter may also be used to indicate that the component of the second asset has been changed. In some instances, the query parameter is appended by the detection module 230 to a path of the second asset (e.g., a location of the second asset in a directory). In other words, although the filename of the second asset remains the same, the query parameter that references the second asset is received by the detection module 230 and appended to the path of the second asset. In further embodiments, the second asset corresponds to an image that is displayed on the web page, and the detection module 230 is configured to detect the change to the component of the second asset based on the an update to the image that is displayed on the web page.

In various example embodiments, the reception module 260 is configured to receive an update to the source code of the second asset. In other words, an asset may be changed or altered during its lifetime. Therefore, more than one version of an asset can exist as a result of the update to the source code. Moreover, the specific feature on the web page may also change as a result of the update to the source code of the second asset. In some instances, the change to the source code of the second asset creates a new feature in the web page. For example, the second asset may correspond to an image that is displayed on the web page. The source code of the second asset may be edited in order to create a new image that is displayed on the web page. Alternatively, the source code of the second asset may be edited in order to modify the image displayed on the web page. In further embodiments, the change to the source code of the second asset modifies the layout or arrangement of the web page. As a result, the reception module 260 is further configured to change the file name of the second asset to a new file name, which may be detected by the detection module 230. In various example embodiments, the reception module 260 is further configured to receive the update to the image that is displayed on the web page.

In various example embodiments, the update module 240 is configured to update the dependency between the first asset and the second asset in response to the detected change. In some instances, the update module 240 updates the dependency based on the change in the file name of the second asset. Moreover, the update module 240 updates the function within the first asset that references the second asset. For example, the update module 240 updates the function in the first asset to include the new file name of the second asset. In this way, the function within the first asset references a correct version of the second asset (e.g., the second asset with the new file name).

In various example embodiments, the update module 240 is further configured to update the dependency between the first asset and the second asset based on a comment included within the first asset that indicates the second asset. The comment may also indicate the second group to which the second asset belongs, such as a shared filename for the second group of assets (e.g., product-reviews). The comment may be placed, by the identification module 220, within a source code of the first asset, such as the function that references the second asset. Moreover, the comment is used by the update module 240 to update the dependency between the first asset and the second asset. In other words, the comment is used by the update module 240 to identify the second asset, and to include the new file name of the second asset in the identified function.

In various example embodiments, the update module 240 is further configured to update the dependency between the first asset and the second asset based on the received query parameter that references the second asset. The dependency between the first asset and the second asset is updated by the update module 240 to include the query parameter that references the second asset.

In various example embodiments, the display module 250 is configured to cause display of the feature of the web page that corresponds to the dependency between the first asset and the second asset. Moreover, the display module 250 causes display of the feature of the web page based on the updated dependency between the first asset and the second asset. In other words, both the first asset and the second asset are used together to cause display of the feature of the web page. The display module 250 may previously have caused display of a previous feature of the web page corresponding to the dependency prior to the second asset being changed. Moreover, once displayed, the previous feature is cached on a client device and referred to, in part, by the previous file name of the second asset for ease of retrieval. As such, when the dependency between the first asset and the second asset is updated and the file name of the second asset is changed, the client device may no longer recognize the newly named second asset. Therefore, the client device sends a request to the asset system 150 to display the feature of the web page. Accordingly, the updated dependency causes the display module 250 to display the feature of the web page corresponding to the updated dependency between the first asset and the second asset. The display module 250 is further to cause display of any new features that result from a change in the source code of any of the assets.

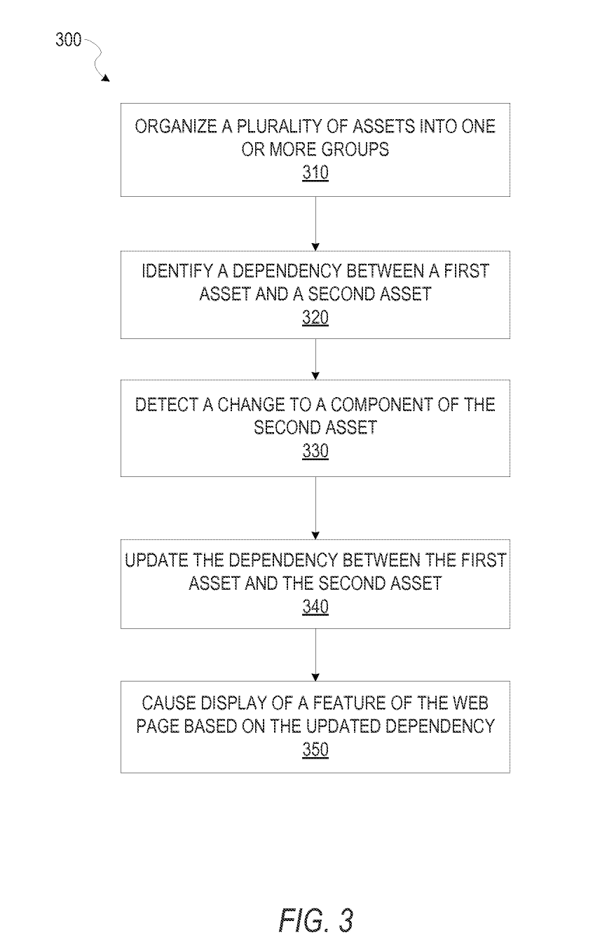

FIGS. 3-5 are flowcharts illustrating operations of the asset system 150 in performing a method 300 of updating a dependency between a first asset and a second asset, according to some example embodiments. Operations in the method 300 are performed by the asset system 150, using modules described above with respect to FIG. 2. As shown in FIG. 3, the method 300 includes operations 310, 320, 330, 340, and 350.

At operation 310, the organization module 210 organizes the plurality of assets into a first group and a second group. Each asset from the plurality of assets is placed within a group based on its association with a specific feature of the web page. For example, assets related to a product page will be placed into the first grouped into the first group, while assets related to a product review page will be grouped into the second group.

At operation 320, the identification module 220 identifies a dependency between a first asset and a second asset. As stated previously, the assets may rely on one another in order to display a specific feature of the web page. For example, an image within the product reviews page may require assets from both groups in order to be displayed. Moreover, the second asset is included in a group that is separate from the first asset. In further instances, the identification module 220 is identifies a dependency between the first asset from the first group of assets and one or more assets from the second group of assets. In this case, the second asset is included in the one or more assets from the second group of assets.

At operation 330, the detection module 230 detects a change to a component of the second asset. A software developer may alter the contents of the second asset, thereby changing the source code of the second asset. As stated earlier, the change to the source code of the second asset may update or edit the specific feature of the web page (e.g., changing an image within the web page, changing a layout of the web page).

At operation 340, the update module 240 updates the dependency between the first asset and the second asset in response to the detected change. In other words, because the second asset is changed, the dependency between the first asset and the second asset is updated in order to reflect the change that occurs in the second asset. In some instances, the update module 240 updates the dependency between the first asset and the second asset based on a comment included in a source code of the first asset that indicates the second asset.

At operation 350, the display module 250 causes display of the feature of the web page based on the updated dependency between the first asset and the second asset. In other words, the feature of the web page corresponding to the dependency between the first asset and the second asset is caused to be displayed in response to the update to the dependency. In one embodiment, the display module 250 sends instructions to a client device to display the feature of the web page.

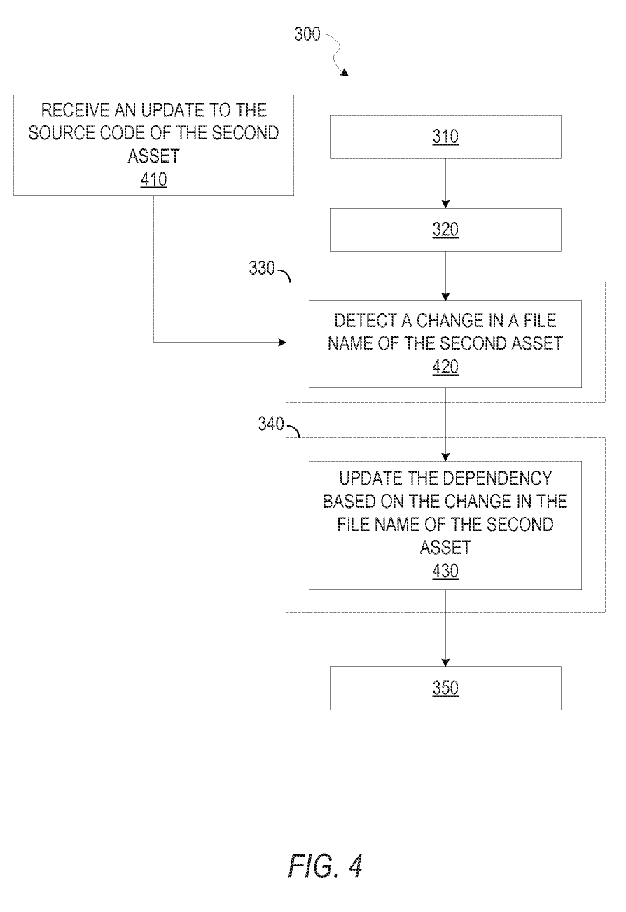

As shown in FIG. 4, the method 300 includes operations 410, 420, and 430. Operation 410 may be performed prior to operation 330. Operation 420 may be included as part of operation 330. Operation 430 may be included as part of operation 340.

At operation 410, the reception module 260 receives an update to the source code of the second asset. The update to the source code of the second asset may be received from a client device operated by a user. For example, a software developer operating the client device submits the update to the source code of the second asset, which is received at the reception module 260.

At operation 420, the detection module 230 detects a change in a file name of the second asset. In some instances, the change in the file name of the second asset is used to indicate that the source code of the second asset has changed.

At operation 430, the update module 240 updates the dependency based on the change in the file name of the second asset. In other words, because the change in the file name of the second asset indicates that the source code of the asset has changed, the update module 240 updates the dependency in response to the change in the file name. As further explained below, this may include changing a function within the first asset that references the second asset.

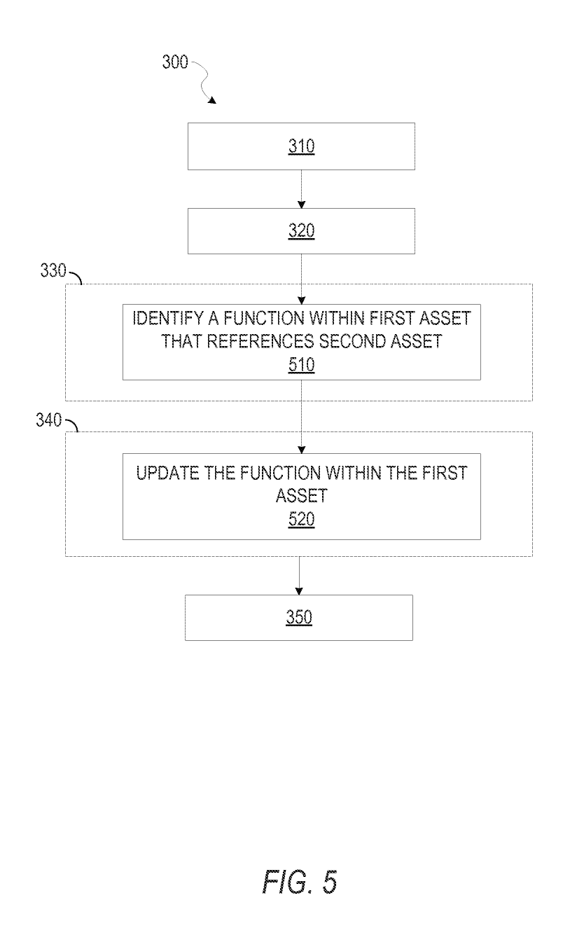

As shown in FIG. 5, the operation 300 includes operations 510 and 520. Operation 510 may be included as part of operation 330. Operation 520 may be included as part of operation 340.

At operation 510, the identification module 220 identifies a function within the first asset that references the second asset. As stated earlier, a dependency between the first and second assets may include a function within the first asset that references the second asset.

At operation 520, the update module 240 updates the function within the first asset. The update module 240 may include the new file name of the second asset within the function that references the second asset.

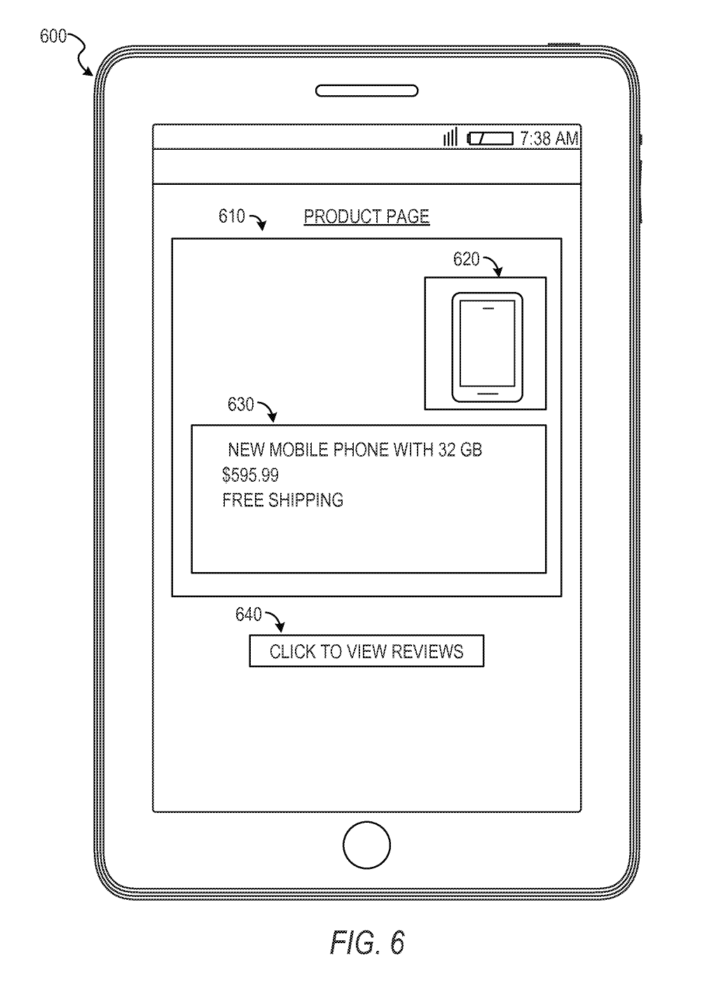

FIG. 6 is a block diagram illustrating an example user interface 600 of a product page 610, according to some example embodiments. The user interface 600 is displayed on a client device of the user. The product page 610 includes an image 620 of a product as well as a description 630 of the product. In some instances, the product page 610 corresponds to a first group of assets. In other words, the first group of assets includes files or source code that is used to cause display of the product page 610. However, the image 620 of the product corresponds to a specific asset from a second group of assets. Therefore, the first group of assets may depend on the specific asset from the second group of assets. The user interface 600 further includes a control 640 that is operable to view reviews for the product displayed in the product page 610.

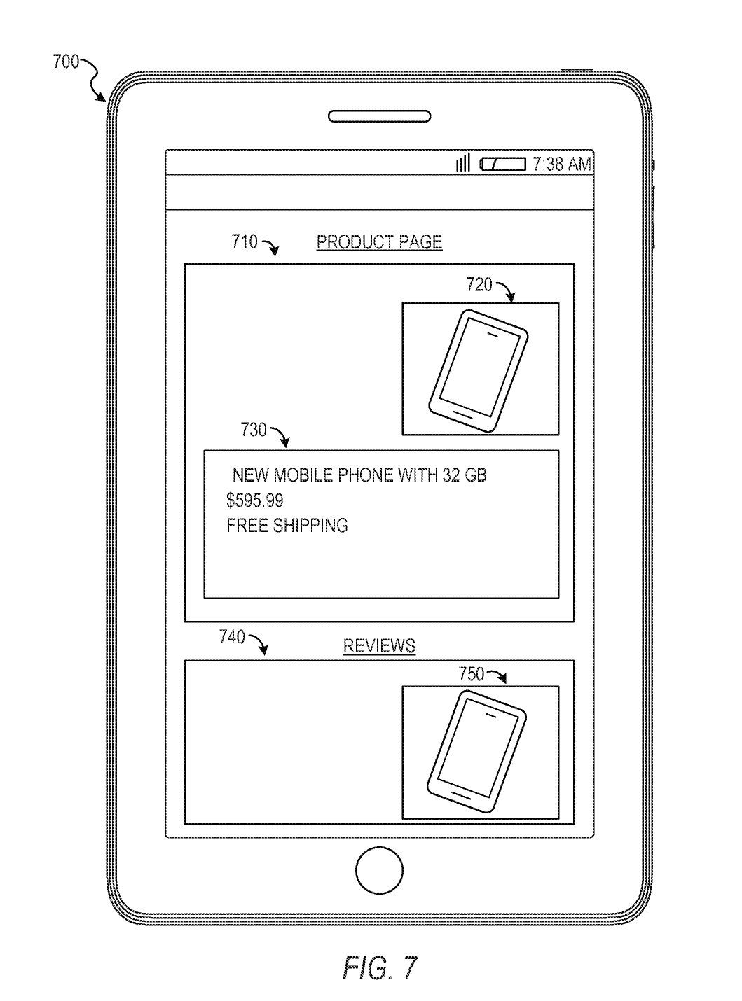

FIG. 7 is a block diagram illustrating an example user interface 700 of a product page 710 and a product reviews page 740, according to some example embodiments. The user interface 700 may be displayed on a client device of the user as a result of operation of the control 640 of FIG. 6. The product page 710 includes a description 730 of the product and an image 720 of the product. Moreover, the image 720 is changed as a result of modifications and is therefore different from the image 620 of FIG. 6. As a result, a filename of the specific asset corresponding to the image 720 is also different from a previous filename corresponding to the image 620. Further, the product reviews page 740 corresponds to a second group of assets, and each asset from the second group of assets is used to cause display of the product reviews page 740. Also, the first group of assets is dependent on the specific asset from the second group of assets corresponding to the image 720. For instance, an asset from the first group of assets may reference the specific asset from the second group of assets as part of a function to display the image 720. Therefore, the function is updated by the update module 240 such that the image 720 is displayed on the client device because the image 620 of FIG. 6 may already be cached on the client device. Moreover, product reviews page 740 also includes an image 750 which corresponds to the same asset used to display the image 720.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Example Machine Architecture and Machine-Readable Medium

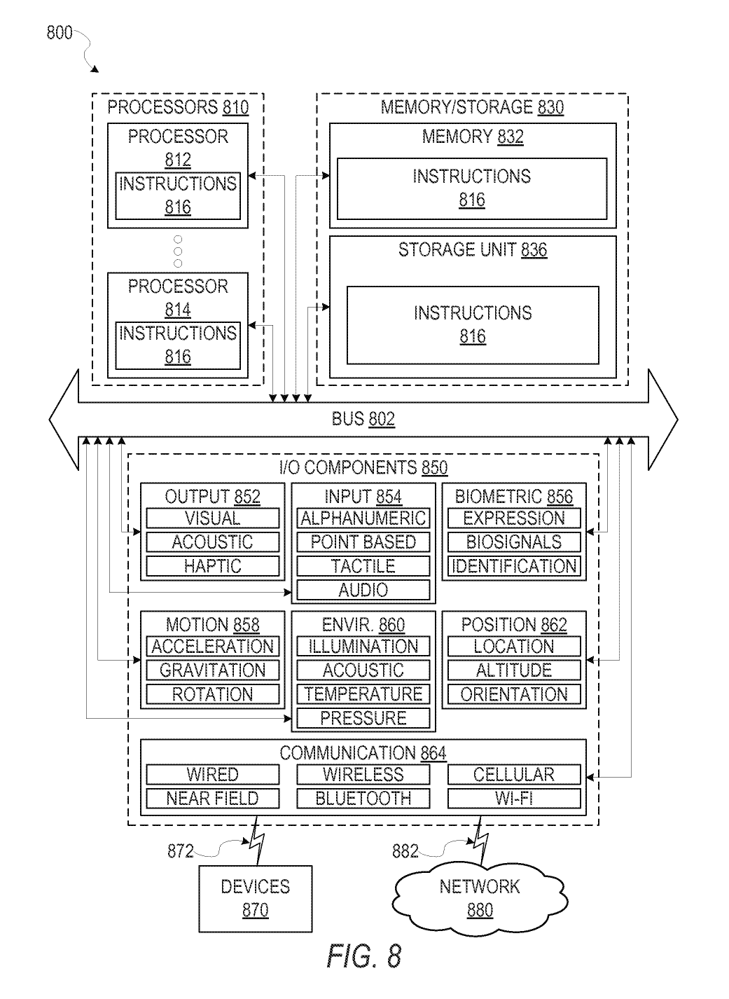

FIG. 8 is a block diagram illustrating components of a machine 800, according to some example embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. For example the instructions may cause the machine to execute the flow diagrams of FIGS. 3-5. Additionally, or alternatively, the instructions may implement the key modules of FIG. 2. The instructions transform the general, non-programmed machine into a particular machine specifically configured to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by machine 800. Further, while only a single machine 800 is illustrated, the term “machine” shall also be taken to include a collection of machines 800 that individually or jointly execute the instructions 816 to perform any one or more of the methodologies discussed herein.

The machine 800 may include processors 810, memory 830, and I/O components 850, which may be configured to communicate with each other such as via a bus 802. In an example embodiment, the processors 810 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 812 and processor 814 that may execute instructions 816. The term “processor” is intended to include multi-core processor that may comprise two or more independent processors (sometimes referred to as “cores”) that may execute instructions contemporaneously. Although FIG. 8 shows multiple processors, the machine 800 may include a single processor with a single core, a single processor with multiple cores (e.g., a multi-core process), multiple processors with a single core, multiple processors with multiples cores, or any combination thereof.

The memory/storage 830 may include a memory 832, such as a main memory, or other memory storage, and a storage unit 836, both accessible to the processors 810 such as via the bus 802. The storage unit 836 and memory 832 store the instructions 816 embodying any one or more of the methodologies or functions described herein. The instructions 816 may also reside, completely or partially, within the memory 832, within the storage unit 836, within at least one of the processors 810 (e.g., within the processor's cache memory), or any suitable combination thereof, during execution thereof by the machine 800. Accordingly, the memory 832, the storage unit 836, and the memory of processors 810 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 816. The term “machine-readable medium” shall also be taken to include any medium, or combination of multiple media, that is capable of storing instructions (e.g., instructions 816) for execution by a machine (e.g., machine 800), such that the instructions, when executed by one or more processors of the machine 800 (e.g., processors 810), cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

Furthermore, the machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The I/O components 850 may include a wide variety of components to receive input, provide output, produce output, transmit information, exchange information, capture measurements, and so on. The specific I/O components 850 that are included in a particular machine will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion and the grouping is in no way limiting. In various example embodiments, the I/O components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 850 may include biometric components 856, motion components 858, environmental components 860, or position components 862 among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 862 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 or devices 870 via coupling 882 and coupling 872 respectively. For example, the communication components 864 may include a network interface component or other suitable device to interface with the network 880. In further examples, communication components 864 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., a peripheral device coupled via a Universal Serial Bus (USB)).

Moreover, the communication components 864 may detect identifiers or include components operable to detect identifiers. For example, the communication components 864 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode. PDF417, Ultra Code, UCC RSS-2D bar code, and other optical codes), or acoustic detection components (e.g., microphones to identify tagged audio signals). In addition, a variety of information may be derived via the communication components 864, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 880 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 880 or a portion of the network 880 may include a wireless or cellular network and the coupling 882 may be a Code Division Multiple Access (CDMA) connection, a Global System for Mobile communications (GSM) connection, or other type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 816 may be transmitted or received over the network 880 using a transmission medium via a network interface device (e.g., a network interface component included in the communication components 864) and utilizing any one of a number of well-known transfer protocols (e.g., hypertext transfer protocol (HTTP)). Similarly, the instructions 816 may be transmitted or received using a transmission medium via the coupling 872 (e.g., a peer-to-peer coupling) to devices 870. The term “transmission medium” shall be taken to include any intangible medium that is capable of storing, encoding, or carrying instructions 816 for execution by the machine 800, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
organizing a plurality of assets into a first group of assets and a second group of assets;
identifying a dependency between a first asset from the first group of assets and a second asset from the second group of assets, the dependency between the first asset and the second asset corresponding to a feature of a web page;
detecting a change to a component of the second asset;
updating, using one or more processors, the dependency between the first asset and the second asset in response to the detected change; and
causing display of the feature of the web page based on the updated dependency between the first asset and the second asset.

2. The method of claim 1 wherein:
the detecting the change to the component of the second asset includes detecting a change in a file name of the second asset; and
the updating the dependency between the first asset and the second asset includes updating the dependency based on the change in the file name of the second asset.

3. The method of claim 1, wherein:
the identifying the dependency between the first asset and the second asset includes identifying a function within the first asset that references the second asset; and
the updating the dependency includes updating the function within the first asset.

4. The method of claim 1, further comprising:
receiving an update to a source code of the second asset from a client device, and wherein the detecting the change to the component of the second asset is based on the received update to the source code of the second asset.

5. The method of claim 4, wherein:
the update to the source code of the second asset creates a new feature of the web page, and
the causing the display of the feature of the web page includes causing display of the new feature of the web page.

6. The method of claim 1, further comprising:
generating a comment in a source code of the first asset that indicates the second asset.

7. The method of claim 6, wherein the updating the dependency between the first asset and the second asset is based on the comment included in the source code of the first asset that indicates the second asset.

8. The method of claim 1, wherein the second asset corresponds to an image that is displayed on the web page, the method further comprising:
receiving an update to the image that is displayed on the web page, and wherein the detecting the change to the component of the second asset is based on the received update to the image that is displayed on the web page.

9. The method of claim 1, wherein:
the detecting the change to the component of the second asset includes receiving a query parameter that references the second asset; and
the updating the dependency between the first asset and the second asset includes updating the dependency based on the received query parameter that references the second asset.

10. The method of claim 1, wherein the plurality of assets includes one or more asset types.

11. A system comprising:
an organization module configured to organize a plurality of assets into one or more groups including a first group of assets and a second group of assets;
an identification module configured to identify a dependency between a first asset from the first group of assets and a second asset from the second group of assets, the dependency between the first asset and the second asset corresponding to a feature of a web page;
a detection module configured to detect a change to a component of the second asset;
an update module configured to update the dependency between the first asset and the second asset in response to the detected change; and
a display module configured to cause display of the feature of the web page based on the updated dependency between the first asset and the second asset.

12. The system of claim 11, wherein:
the detection module is further configured to detect a change in a file name of the second asset; and
the update module is further configured to update the dependency based on the change in the file name of the second asset.

13. The system of claim 11, wherein:
the identification module is further configured to identify a function within the first asset that references the second asset, and
the update module is further configured to update the function within the first asset.

14. The system of claim 11, further comprising a reception module configured to receive an update to a source code of the second asset from a client device, and wherein the detection module is further configured to detect the change to the component of the second asset based on the received update to the source code of the second asset.

15. The system of claim 14, wherein:
the update to the source code of the second asset creates a new feature of the web page, and
the causing the display of the feature of the web page includes causing display of the new feature of the web page.

16. The system of claim 11, wherein the identification module is further configured to generate a comment in a source code of the first asset that indicates the second asset.

17. The system of claim 16, wherein the update module is further configured to update the dependency between the first asset and the second asset based on the comment included in the source code of the first asset that indicates the second asset.

18. The system of claim 11, wherein:
the second asset corresponds to an image that is displayed on the web page; the reception module is further configured to receive an update to the image that is displayed on the web page; and
the detection module is further configured to detect the change to the component of the second asset based on the received update to the image that is displayed on the web page.

19. The system of claim 11, wherein:
the detection module is further configured to receive a query parameter that references the second asset; and
the update module is further configured to update the dependency based on the received query parameter that references the second asset.

20. A non-transitory machine readable medium storing instructions that, when executed by one or more processors of a machine, cause the machine to perform operations comprising:
organizing a plurality of assets into a first group of assets and a second group of assets;
identifying a dependency between a first asset from the first group of assets and a second asset from the second group of assets, the dependency between the first asset and the second asset corresponding to a feature of a web page;
detecting a change to a component of the second asset;
updating the dependency between the first asset and the second asset in response to the detected change; and
causing display of the feature of the web page based on the updated dependency between the first asset and the second asset.
